(19) United States
(12) Patent Application Publication
(10) Pub. No.: US 2024/0165730 A1
(43) Pub. Date: May 23, 2024

(54) WELDING METHOD

(71) Applicant: Industrial Technology Research Institute, Chutung (TW)

(72) Inventors: Tsung-Ying TSAI, Chutung (TW); Kuang-Yao HUANG, Chutung (TW); Shih-Kai CHIEN, Chutung (TW)

(21) Appl. No.: 18/150,757

(22) Filed: Jan. 5, 2023

(30) Foreign Application Priority Data
Nov. 23, 2022 (TW) 111144891

(51) Int. Cl. B23K 9/095

(52) U.S. Cl. CPC B23K 9/0953

(57) ABSTRACT

The present disclosure provides a welding method, which comprise the following steps: setting up a laser welding head of a laser welding machine to perform a welding operation in a manner of swing or rotating, so that a swing path of the laser welding head relative to a processing direction of the laser welding head is defined with a deceleration zone and an acceleration zone, such that the laser welding head reduces a relative swing speed or feeding speed in the acceleration zone to avoid an undercutting occurred in a welding path of the welding process.

### BACKGROUND

### 1. Technical Field

The present disclosure relates to a laser welding technique, in particular to a swing laser welding method.

### 2. Description of Related Art

With the vigorous development of the semiconductor industry, in response to the large increase in the demand for components used in semiconductor factories, those components are manufactured in a manner of laser welding to effectively solve the problems of labor shortage and insufficient manufacturing capacity under the large demand.

In recent years, the laser industry has developed a laser swing or laser wobble welding machine, so that the appearance and even the quality of the overall processed object may be improved after operating the laser swing welding operation at low speeds (the swing welding speed is about 1/10˜⅓ of that of general laser welding operation, such as 30 mm/s). Therefore, the welding operation of the pipe used in the factory currently adopts the laser swing welding method.

However, when the welding speed (i.e., the feeding speed) of the laser swing welding operation is increased, welding structural problems may occur. For example, when the welding speed is increased to more than 30 mm/s, the undercutting is likely to occur, and thus easily causes the lack of overall structural strength. On the other hand, when the welding speed of the laser swing welding operation is increased, it is necessary to adopts remelting or refilling method after processing to eliminate the cave caused by the undercutting, such that resulting in increasing the operation time and material cost. Therefore, the present industry adopts low-speed welding in the whole welding process to suppress the undercutting, which is hard to speed up the processing.

Therefore, how to speed up the laser swing welding operation while keeping the quality has become a problem that the industry needs to overcome urgently.

### SUMMARY

In view of the aforementioned shortcomings of the prior art, the present disclosure provides a welding method of which a host computer executing the following steps: driving a laser welding head by a controller and performing a welding operation in a manner of swing to form a swing path, wherein the swing path of the laser welding head is defined with a deceleration zone and an acceleration zone relative to a processing direction of the laser welding head; and reducing a relative swing speed of the laser welding head in the acceleration zone during performing the welding operation to avoid causing an overcutting in the acceleration zone.

As can be understood from the above, in the welding method according to the present disclosure, the relative swing speed is mainly reduced by the partial path (a middle section of the acceleration zone) of the swing path of the laser welding head, so that the laser welding head performs swinging motion with different speeds to avoid undercutting defects generated by the swing welding operation, such that there is no need to perform remedial work of conventional remelting and filling methods. Therefore, compared with the prior art, the welding method of the present disclosure can simultaneously achieve the effects of high-speed welding and high-quality processing.

### BRIEF DESCRIPTION OF THE DRAWINGS

FIG. 1 is a flow block diagram of a welding method of the present disclosure.

FIG. 2 is a schematic diagram of a swing path of the welding method of the present disclosure.

FIG. 3 is a schematic of a configuration of processing equipment used in the welding method of the present disclosure.

FIG. 4A, FIG. 4B and FIG. 4C are schematic diagrams of various embodiments of the middle section of an acceleration zone of the swing path of the welding method of the present disclosure.

### DETAILED DESCRIPTION

Implementations of the present disclosure are described below by embodiments. Other advantages and technical effects of the present disclosure can be readily understood by one of ordinary skill in the art upon reading the disclosure of this specification.

It should be noted that the structures, ratios, sizes shown in the drawings appended to this specification are provided in conjunction with the disclosure of this specification in order to facilitate understanding by those skilled in the art. They are not meant, in any ways, to limit the implementations of the present disclosure, and therefore have no substantial technical meaning. Without influencing the effects created and objectives achieved by the present disclosure, any modifications, changes or adjustments to the structures, ratios or sizes are construed as fall within the scope covered by the technical contents disclosed herein. Meanwhile, terms such as “above,” “first,” “second,” “one,” “a,” “an,” and the like, are for illustrative purposes, and are not meant to limit the scope implementable by the present disclosure. Any changes or adjustments made to the relative relationships, without substantially modifying the technical contents, are also to be construed as within the scope implementable by the present disclosure.

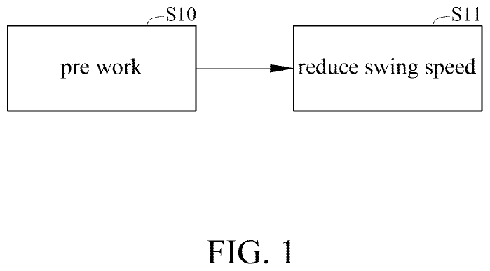

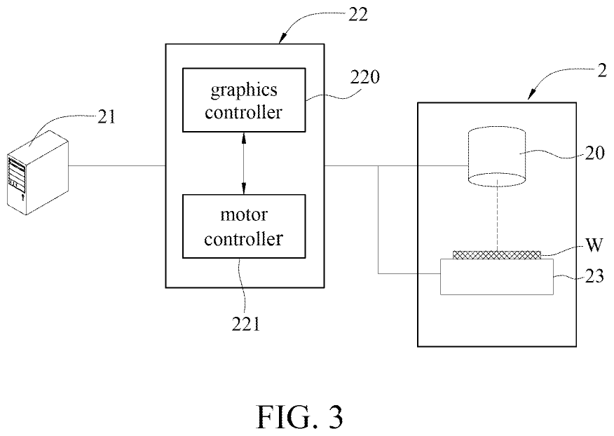

FIG. 1 is a flow block diagram of a welding method according to an embodiment of the present disclosure. In this embodiment, a processing equipment 2 (as shown in FIG. 3) equipped with a laser welding head 20 and connected to a controller 22 and a computer host 21 is configured to operate the welding method.

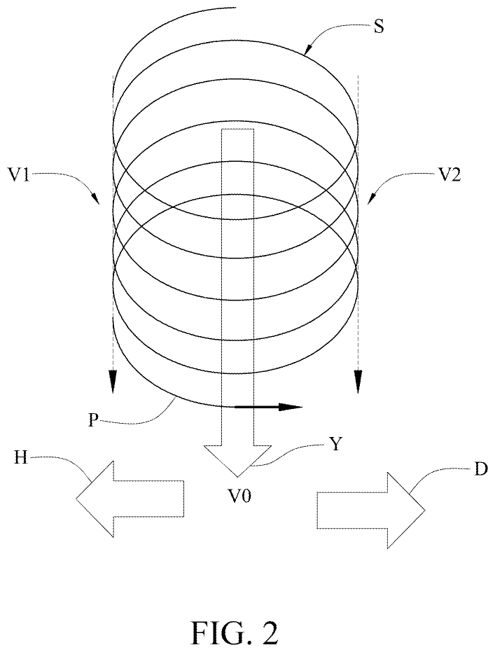

In step S10, a pre work is performed. First, a laser welding head 20 is provided, as shown in FIG. 3, which is set to perform a welding operation in a manner of swinging or rotating. Then, a swing path S of the laser welding head 20 is set, as a circular trajectory shown in FIG. 2, in which the swing path S of the laser welding head 20 is defined with a deceleration zone D and an acceleration zone H relative to a processing direction Y (or feeding direction) of the laser welding head 20.

In this embodiment, the laser welding head 20 is installed in a processing equipment 2, such as a laser welding machine, and the processing equipment 2 is further configured with a controller 22 which is used to drive a working platform 23 for placing at least one target processing object W. The welding method according to the embodiment of the present disclosure is stored or installed in a host computer 21 connected to the controller 22 in a form of a software program or an electronic circuit. The host computer 21 has a processor, a memory and a communicator (not shown); the controller 22 has a graphics controller 220 and a motor controller 221. The host computer 21 connects the graphics controller 220 and the motor controller 221 by the communicator, so that the graphics controller 220 and the motor controller 221 receives software instructions or electronic signals stored in the memory by the processor of the host computer 21 to drive the laser welding head 20 to move or swing relative to the working platform 23. For example, the graphics controller 220 defines a moving path of the laser welding head 20 (including the swing path S, a processing path, etc.), and the motor controller 221 drives the processing actions of the laser welding head 20 (including swinging, rotating, etc.).

Furthermore, the acceleration zone H (left side of FIG. 2) is an area where the processing direction Y of the laser welding head 20 and the swing direction P (downward in FIG. 2) are relatively in the same direction, and the deceleration zone D (right side of FIG. 2) is an area where the processing direction Y of the laser welding joint 20 and the swing direction P (upward in FIG. 2) are relatively in the opposite direction. For example, the processing direction Y (or feeding direction) of the laser welding head 20 is downward in FIG. 2, if the swing direction P of the laser welding head 20 is a counterclockwise direction of the swing path S of the circular trajectory, then the acceleration zone H will be formed in an equivalent area of the ½ circumference of the left half of the circular trajectory (i.e., the swing is facing downward), and the deceleration zone D will be formed in an equivalent area of the ½ circumference of the right half of the circular trajectory (i.e., the swing is facing upward).

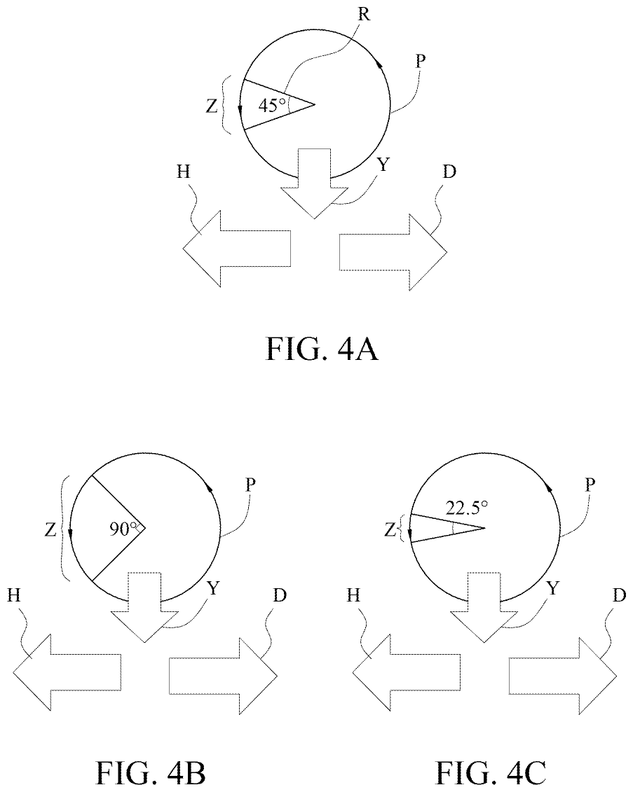

In other words, if the welding speed (or feeding speed) of the laser welding head 20 that is V0 and the rotating speed or rotation vector that is 2πRf both of which are fixed values, the relative swing speed V1=2πRf+V0 of the laser welding head 20 in the acceleration zone H is the maximum value and the relative swing speed V2=2πRf−V0 of the laser welding joint 20 in the deceleration zone D is the minimum value, where R represents the swing radius (the radius R of the circular trajectory shown in FIG. 4A), and f represents the swing frequency. Therefore, it should be understood that the acceleration zone H and the deceleration zone D are relative different speed zone since the cooperation between the processing direction Y and the swing direction P of the laser welding head 20.

In step S11, the laser welding head 20 needs to reduce the relative swing speed V1 or reduce the welding speed V0 in the acceleration zone H during the welding process to avoid overcutting.

In this embodiment, since the acceleration zone H is the equivalent area of the ½ circumference of the circular trajectory, the laser welding head 20 can reduce the relative swing speed V1 in the middle section Z of the acceleration zone H of the swing path S (i.e., the section where the maximum value of the relative swing speed occurs). For example, the middle section Z can be defined as a section of ⅛ of the circumference of the circular trajectory (as a 45-degree arc section shown in FIG. 4A), a section of ¼ of the circumference (as a 90-degree arc section shown in FIG. 4B) or a section of 1/16 circumference (as a 22.5-degree arc section shown in FIG. 4C), but not limit to the above in the present disclosure, and the way to reduce the relative swing speed V1 can be, for example, reducing the welding speed V0 or the swing frequency f.

Furthermore, as illustrating in the following table, for example, under the condition that the welding speed V0 of the laser welding head 20 is greater than 100 mm/s, the graphics controller 220 and the motor controller 221 perform an adjustment of different swing speeds of the laser welding head 20 in a specific section (the middle section Z of the acceleration zone H), the results are shown in the table below:

| Adjustment | The relative swing speed V1 | Size of |
|---|---|---|
| condition | (mm/s) of the middle section Z | undercutting(μm) |
| The relative swing | 700 | 116.76 |
| speed remained in | | |
| original speed | | |
| The relative swing | 300 | 63.01 |
| speed with 60% | | |
| reduction | | |
| The relative swing | 110 | 0(even |
| speed with 85% | | protruding) |
| reduction | | |

Therefore, by reducing the relative swing speed V1 of the laser welding head 20 by 60% to 85% of the maximum swing speed value in the acceleration zone H, the defects of undercutting or cave can be reduced. For example, from the original undercutting size (or segment difference) of 116.76 micrometers becoming a smaller segment difference of 63.01 micrometers, or even eliminating the undercutting.

Also, since the opposite sides of the cave formed by the undercutting are asymmetrical and one side in a specific direction is more inclined, it can be seen that the swing path S of the swinging type is more prone to have undercutting in a specific section. For example, there is a difference between acceleration and deceleration on the opposite sides of the cave, and the middle section Z of the acceleration zone H is more prone to have a more obvious inclination, so the middle section Z of the acceleration zone H of the swing path S is used as a section requiring speed regulation during the path control of the laser welding head 20, such as a section of ⅛ of the circumference of a circular trajectory, to reduce undercutting and even eliminate undercutting defects.

In addition, a process performed by the laser welding head 20 in the acceleration zone H is prone to have undercutting, while a process performed by the laser welding head 20 in the deceleration zone D has no undercutting. Specifically, undercutting occurs due to recoil force squeezing the fluid (such as solder) caused by laser processing, but when the heat source is far away, the fluid stress will be dominated by the Marangoni effect which makes the molten pool backfill. With the Marangoni number, it can be confirmed that the larger the temperature difference near the fluid surface, the more Marangoni effect will increase, making the undercutting to be backfilled. Therefore, once the central temperature is high and the molten pool is maintained enough for a long time, the undercutting defect can be improved (i.e., since the cooling time is long, the reaction time will be sufficient for backfilling), so a place with the fastest speed will be the place mostly prone to have undercutting (a hardest place to backfill).

It can be seen from the above that through the reduction of the local (middle section Z of the acceleration zone H) relative swing speed, the heat action time of the fluid can be increased. That is, the center temperature is increased, and a certain heating effect is remained after the center of the heat source leaving to maintain the state of the molten pool, so that the place with undercutting is backfilled.

In view of the above, in the wielding method of the present disclosure, the laser welding head of the swing welding operation is swinging at different speeds in a manner of section parameter control under the same laser welding speed (feeding speed), so as to effectively eliminate the undercutting defect produced by the swing welding operation and without performing remedial work of conventional remelting and filling methods, so the welding method according to the present disclosure can simultaneously achieve the effects of high-speed welding and high-quality processing.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. A welding method stored in a memory of a host computer and read by the host computer to execute following steps:
driving a laser welding head by a controller and performing a welding operation set with a swing or rotating manner to form a swing path, wherein the swing path is defined with a deceleration zone and an acceleration zone relative to a processing direction of the laser welding head; and
reducing a relative swing speed of the laser welding head in the acceleration zone during performing the welding operation, wherein the relative swing speed is a relative speed between a feeding speed and a rotation vector of the laser welding head.

2. The method of claim 1, wherein the swing path is a circular trajectory.

3. The method of claim 1, wherein the acceleration zone is an area where the processing direction and the swing direction of the swing path are relatively in a same direction.

4. The method of claim 1, wherein the relative swing speed of the laser welding head is reduced in a middle section of the acceleration zone.

5. The method of claim 4, wherein the middle section is a section of which the maximum value of the relative swing speed occurs.
